(19) United States
(12) Patent Application Publication
(10) Pub. No.: US 2012/0308186 A1
(43) Pub. Date: Dec. 6, 2012

(54) TRANSFER MEMBER ASSEMBLY

(76) Inventor: Andre Martin Van der Ende, Udny Green (GB)

(21) Appl. No.: 13/579,200

(22) PCT Filed: Feb. 18, 2011
(86) PCT No.: PCT/GB11/00225

§ 371 Date: Aug. 15, 2012

(30) Foreign Application Priority Data
Feb. 18, 2010 (GB) 1002788.6

(51) Int. Cl. G02B 6/44; H02G 3/04; F16L 9/14; B23P 17/00

(52) U.S. Cl. 385/109; 29/527.1; 385/100; 174/68.3; 138/140

(57) ABSTRACT

A transfer member assembly 2 comprises a transfer member 4 for the transfer of a signal, power or fluid such as an optical fibre, an electrical conductor or a gas or hydraulic line. The transfer member assembly 2 comprises a shroud 6 formed around the transfer member 4 and a composite material 8 comprising a matrix formed around the shroud 6. The composite material 8 comprises longitudinal fibres in a resin matrix. The resin matrix penetrates at least part-way into the shroud 6. The penetration of the matrix into the shroud 6 is controlled during manufacture of the transfer member assembly 2, for example by controlling shroud permeability or by controlling the resin viscosity or pressure utilised in a pultrusion process utilised to form the composite.

### FIELD OF THE INVENTION

The present invention relates to a transfer member assembly and a method of manufacturing thereof and, in particular, though not exclusively to a method of manufacturing an optical fibre assembly to make the optical fibre assembly less susceptible to damage during bending or under extreme environmental conditions either during or after manufacture. The assembly may form part of a reelable support, such as a slickline or wireline.

### BACKGROUND OF THE INVENTION

Optical fibres are susceptible to damage caused by the application of excessive physical forces and/or to exposure to extreme environmental conditions such as excessive temperatures. For example, micro-cracking is a well-known failure mode that may be induced by exceeding a fibre tensile stress limit and/or subjecting the fibre to a temperature above a maximum rated temperature. Such damage may, for example, arise in the fibre during the fibre manufacturing process. For example, optical fibres are often embedded in a composite material comprising a resin and structural fibres to enhance tensile strength and provide protection from mechanical damage and environmental conditions. During application of the composite material around the fibre by a pultrusion or rollforming process, however, the fibre is generally exposed to a combination of pulling forces and high temperatures for curing of the resin.

To at least partially reduce the extent of such damage to the optical fibre or to at least partially reduce the probability of such damage to the optical fibre either during or after the embedding of the optical fibre in the composite material, it is well known to protect the optical fibre by accommodating the optical fibre in a loose-fitting metal or plastic tube which may be dry or gel-filled prior to embedding the optical fibre in the composite material. Such a method of protecting an optical fibre is often known as loose-tube buffering and provides protection from temperature induced stresses. However, loose-tube buffering also requires the length of optical fibre inserted within the tube to be greater than the length of the tube so that the fibre follows a non-linear path inside the tube. Such a method of inserting an optical fibre into a tube can be a relatively complex and time-consuming operation.

Alternatively, to protect the optical fibre during the embedding of the optical fibre in the composite material, it is also well known to extrude a protective plastic coating around the optical fibre. Such a method is known as tight-buffering and can result in additional stresses on the optical fibre due to discrepancies in the thermal expansion behaviour of the different coating and fibre materials.

Prior art optical fibre assemblies comprising composite material strength members thus generally comprise an interface between two different materials. For the case of loose-tube buffering, for example, an interface exists between the composite material and the tube, while for the case of tight buffering, an interface exists between the composite material and the coating. Failure of such optical fibre assemblies has been shown to occur as a result of shearing between adjacent layers at such interfaces during bending or under extreme environmental conditions either during or after manufacture.

### SUMMARY OF THE INVENTION

According to a first aspect of the present invention there is provided a method of manufacturing a transfer member assembly comprising: locating a shroud around a transfer member; forming an elongate body comprising a settable material around the shroud; and controlling penetration of the settable material into the shroud so that the settable material extends at least part way into the shroud.

The transfer member may comprise a signal, power or fluid transfer member such as an optical fibre, an electrical conductor or a gas or hydraulic line.

The transfer member may comprise an optical fibre having a core and a cladding.

The transfer member may comprise an optical fibre having a coating. For example, the transfer member may comprise an optical fibre having an acrylate coating.

The transfer member may comprise a hollow tube with an optical fibre therein.

The optical fibre may be a loose-buffered optical fibre.

The optical fibre may be over-stuffed.

The hollow tube may comprise a gel-based material.

The transfer member may comprise a support member surrounded by an optical fibre. For example, the transfer member may comprise a support member and an optical fibre helically arranged around the support member.

The support member may comprise a gel-based material.

The gel-based material may exhibit thixotropic behaviour. The gel-based material may, in particular, be transformed into a gel by heat and/or mechanical forces applied to the gel-based material during manufacturing of the transfer member and/or during manufacturing of the transfer member assembly.

Transformation of such a gel-based material into a gel in this way may provide additional protective cushioning for an optical fibre of the transfer member.

The transfer member may be located centrally within the transfer member assembly.

Such a method may permit the formation of a transition zone between the body and the shroud thus serving to reduce the probability of shearing between the body and the shroud during bending or under extreme environmental conditions either during or after manufacture. Controlling penetration of the settable material into the shroud may allow the shroud to provide radial support for a transfer member within the shroud whilst still allowing longitudinal movement of the transfer member relative to the shroud.

The shroud may comprise a layer or sheet of material. The shroud material may take any appropriate form, and may be a membrane, one or more wrapped layers, a woven or non-woven material, or one or more coils of a fibre or filament.

The shroud may be porous or permeable to the settable material.

The shroud may be flexible or rigid.

The shroud may comprise at least one filament. For example, the shroud may comprise at least one elongate member such as a fibre or a strand or the like. The at least one filament may comprise at least one monofilament, nanotube or the like.

The shroud may comprise at least one filament having a generally uniform cross-section.

The shroud may comprise at least one filament having a generally circular cross-section or a cross-section of any other shape.

The shroud may comprise at least one filament having a generally non-uniform cross-section.

The shroud may comprise at least one filament comprising any suitable material, such as a para-aramid, a meta-aramid, glass, PBO and carbon, such as the fibres sold under the trademarks Kevlar, Zylon, 12k Thornel, Twaron and E-glass. The at least one filament may comprise a metal. The at least one filament may comprise steel.

The shroud may comprise at least one filament formed into a coil. The shroud may comprise a plurality of filaments wherein each filament is formed into a corresponding coil.

The method may comprise controlling the formation of the shroud and/or the composite material to control penetration of the settable material into the shroud.

The method may comprise controlling the formation of the shroud and/or the body to prevent penetration of the settable material beyond an inner surface of the shroud.

The method may comprise selecting the shroud and/or the settable material to control penetration of the material into the shroud.

The method may comprise selecting the shroud material to have a predetermined porosity or permeability to the settable material.

The method may comprise forming the shroud with a predetermined porosity to the settable material.

The method may comprise forming the shroud with a predetermined thickness.

The method may comprise controlling the formation of the shroud and/or the settable material to form a predetermined distribution of the material in the shroud.

The method may comprise controlling the formation of the shroud and/or the settable material to provide a gradually decreasing volume of settable material in the shroud between the elongate body and the transfer member. For example, there may be linear, exponential, stepped or even random distribution of the material over the thickness of the shroud.

The method may comprise wrapping the shroud around an outer surface of the transfer member. As used herein, the term wrapping includes a helical wrap and a cigarette-paper like wrap. The shroud may be formed of a single layer of material or may be formed of multiple layers of material. The edges of individual layers may be spaced apart, abutting or overlapping.

The method may comprise wrapping at least one shroud element, such as a tape or a filament, around the transfer member.

The method may comprise wrapping at least one shroud element around the transfer member, wherein the at least one element has little or no tensile strength function but serves primarily to provide a volume surrounding the transfer member over which the volume or proportion of settable material may transition.

The method may comprise controlling the wrapping of at least one shroud element around the transfer member to form the shroud.

The method may comprise controlling one or more properties of at least one shroud element wrapped around the transfer member to form the shroud.

The method may comprise controlling the configuration of at least one shroud element wrapped around the transfer member to form the shroud.

The method may comprise controlling at least one of the shape, size, and the wrapping arrangement of at least one shroud element around the transfer member. The method may, for example, comprise controlling at least one of the length, diameter, and wrapping arrangement of at least one shroud element around the transfer member.

Controlling the shape, size, and/or wrapping arrangement of at least one shroud element around the transfer member may be used to control the penetration of the settable material into the shroud and therefore the distribution of shear stresses between the elongate body and the shroud during bending or other due to temperature changes.

The method may comprise controlling the number of shroud elements wrapped around the transfer member.

Controlling the number of shroud elements may be used to control the thickness of the shroud and therefore the distribution of shear stresses between the elongate body and the shroud during bending.

The method may comprise helically wrapping at least one shroud element around the transfer member.

The method may comprise wrapping at least one shroud element around the transfer member in the form of a helix. The method may comprise controlling a property of the helix such as the radius or pitch of the helix.

The method may comprise wrapping at least one shroud element around the transfer member and subsequently wrapping at least one further shroud element around the at least one shroud element.

The method may comprise helically wrapping at least one shroud element around the transfer member and subsequently helically wrapping at least one further shroud element around the at least one shroud element.

The method may comprise wrapping at least one shroud element around the transfer member and subsequently wrapping at least one further shroud element around the at least one shroud element in a direction opposite to a direction in which the at least one shroud member is wrapped around the transfer member.

The method may comprise wrapping at least one shroud element around the transfer member and subsequently wrapping at least one further shroud element around the at least one shroud element at an angle relative to the at least one shroud element such that the at least one further shroud element crosses the at least one shroud element.

The method may comprise applying the settable material to an outer surface of the shroud.

The elongate body may comprise solely or primarily a settable material, or may comprise a composite material. The composite material may comprise a matrix comprising a settable material and fibres or filaments distributed within the matrix.

The composite material may comprise a plurality of fibres, filaments or the like, hereinafter referred to as filaments. The filaments may extend solely or primarily longitudinally, or be in any other direction or formation. Individual fibres or filaments may be of a length substantially equal to the elongate body, or may be shorter than the body.

The filaments of the composite material may comprise any suitable material, such as a para-aramid, a meta-aramid, glass, PBO and carbon, such as the filaments sold under the trademarks Kevlar, Zylon, 12k Thornel, Twaron and E-glass.

The method may comprise wrapping or otherwise arranging at least one filament around the transfer member to form the shroud wherein the at least one filament forming the shroud has the same or similar properties of at least one filament of the composite material.

The method may comprise wrapping or otherwise arranging at least one filament around the transfer member to form the shroud wherein the at least one filament forming the shroud is of the same or similar type as at least one filament of the composite material.

The method may comprise wrapping or otherwise arranging at least one filament around the transfer member to form the shroud wherein the at least one filament forming the shroud is formed of the same or similar material as at least one filament of the composite material.

The method may comprise wrapping or otherwise arranging at least one filament around the transfer member to form the shroud wherein the at least one filament forming the shroud is formed using the same or similar process used to form at least one filament of the composite material.

The method may comprise selecting a settable material comprising polyvinylidene fluoride (PVDF).

The method may comprise selecting a settable material comprising a thermoplastic material, such as PEEK. The method may comprise selecting a settable material comprising an elastomer, for example a perfluoroelastomeric material such as sold under the Kalrez trademark. The method may comprise selecting a settable material comprising a thermosetting material.

The method may comprise forming the shroud and/or body material under controlled environmental conditions such as controlled temperature, pressure or the like.

The method may comprise mechanically compressing the shroud and/or body around the transfer member.

The method may comprise controlling the mechanical compression of the shroud and/or body around the transfer member.

The method may comprise forming the shroud and/or body using a pultrusion process.

According to a second aspect of the present invention there is provided a transfer member assembly comprising: a transfer member; a shroud around the transfer member; and an elongate body comprising a settable material formed around the shroud, wherein the settable material matrix penetrates at least part way into the shroud.

It should be understood that any of the optional features associated with the first aspect may also apply alone or in any combination to the transfer member assembly of the second aspect.

The transfer member may comprise a signal, power or fluid transfer member such as an optical fibre, an electrical conductor or a gas or hydraulic line, or a hollow tube with a loose-buffered optical fibre therein.

The transfer member may comprise an optical fibre having a core and a cladding.

The transfer member may comprise an optical fibre having a coating. For example, the transfer member may comprise an optical fibre having an acrylate coating.

The shroud may comprise a layer or sheet of material.

The shroud may be porous or permeable to the settable material.

The shroud may be flexible or rigid.

The shroud may comprise at least one filament. For example, the shroud may comprise at least one elongate member such as a fibre or a strand or the like. The at least one filament may comprise at least one monofilament, nanotube or the like.

The shroud may comprise at least one filament having a generally uniform cross-section.

The shroud may comprise at least one filament having a generally circular cross-section or a cross-section of any other shape.

The shroud may comprise at least one filament having a generally non-uniform cross-section.

The shroud may comprise at least one filament comprising any suitable material, such as a para-aramid, a meta-aramid, glass, PBO and carbon, such as the filaments sold under the trademarks Kevlar, Zylon, 12k Thornel, Twaron and E-glass. The at least one fibre may comprise a metal. The at least one fibre may comprise steel.

The shroud may comprise at least one shroud element, such as a filament, formed into a coil. The shroud may comprise a plurality of shroud elements wherein each element is formed into a corresponding coil.

The shroud may comprise at least one shroud element wrapped around the transfer member.

The shroud may comprise at least one shroud element helically wrapped around the transfer member.

The shroud may comprise at least one shroud element wrapped around the transfer member and at least one further shroud element wrapped around the at least one shroud element.

The shroud may comprise at least one shroud element helically wrapped around the transfer member and at least one further shroud element helically wrapped around the at least one shroud element.

The shroud may comprise at least one shroud element wrapped around the transfer member and at least one further shroud element wrapped around the at least one shroud element, wherein the at least one further shroud element is wrapped in a direction opposite to a direction in which the at least one shroud element is wrapped around the transfer member.

The shroud may comprise at least one shroud element wrapped around the transfer member and at least one further shroud element wrapped around the at least one shroud element, wherein the at least one further shroud element is wrapped at an angle relative to the at least one shroud element wrapped around the transfer member such that the at least one further shroud element crosses the at least one shroud element.

The elongate body may comprise solely or primarily a settable material, or may comprise a composite material. The composite material may comprise a matrix comprising a settable material and fibres or filaments distributed within the matrix.

The settable material may comprise polyvinylidene fluoride (PVDF).

The settable material may comprise a thermoplastic material, such as PEEK. The settable material may comprise an elastomer, for example a perfluoroelastomeric material such as sold under the Kalrez trademark. In other embodiments the settable material may be a thermosetting material.

The settable material may comprise an adhesive, an epoxy or a resin.

The body may comprise a plurality of elongate elements, such as fibres or filaments. The plurality of elongate element may comprise any suitable material, such as a para-aramid, a meta-aramid, glass, PBO and carbon, such as the filaments sold under the trademarks Kevlar, Zylon, 12k Thornel, Twaron and E-glass.

The transfer member assembly may comprise a plurality of transfer members.

According to a third aspect of the present invention there is provided a transfer member assembly comprising: a transfer member; and an elongate body surrounding the transfer member and comprising a settable material, the body including a transition layer adjacent the transfer member, the proportion of settable material present in the transition layer decreasing with increasing proximity to the transfer member.

The transition layer may be pre-formed, pre-filled or otherwise impregnated with settable material prior to being located around the transfer member. Alternatively, or in addition, settable material may be impregnated or otherwise supplied as the transition layer is formed around the transfer member.

The transition layer may be formed separately of or simultaneously with other parts of the elongate body.

According to a fourth aspect of the present invention there is provided a cable comprising the transfer member assembly according to the second or third aspect.

According to a fifth aspect of the present invention there is provided a reelable support comprising a transfer member assembly according to the second or third aspect.

The reelable support may comprise a slickline, wireline or the like.

### BRIEF DESCRIPTION OF THE DRAWINGS

The present invention will now be further described by way of non-limiting example only with reference to the following drawings of which:

FIG. 1(a) is a schematic representation of an optical fibre assembly constituting an embodiment of the present invention;

FIG. 1(b) is a cross section of the optical fibre assembly of FIG. 1(a);

FIG. 2(a) schematically illustrates an optical fibre sub-assembly formed during the manufacture of the optical fibre assembly of FIG. 1(a);

FIG. 2(b) schematically illustrates an optical fibre sub-assembly formed subsequent to the step illustrated in FIG. 2(a) during the manufacture of the optical fibre assembly of FIG. 1(a);

FIG. 3 schematically illustrates the manufacture of the optical fibre assembly of FIG. 1(a);

FIG. 4 schematically illustrates the percentage by volume of settable material in the optical fibre assembly of FIG. 1(a); and

FIG. 5 schematically illustrates the percentage by volume of settable material in an alternative embodiment of an optical fibre assembly.

### DETAILED DESCRIPTION OF THE DRAWINGS

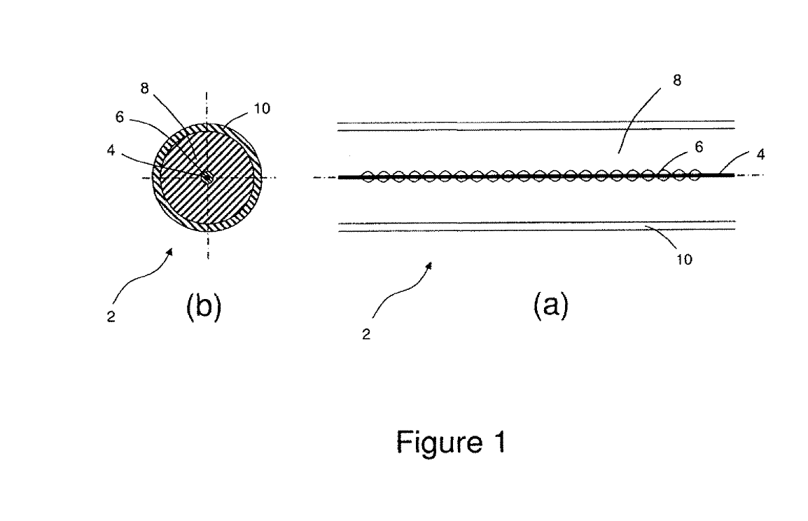

With reference initially to FIGS. 1(a) and 1(b) there is shown a transfer member assembly in the form of an optical fibre assembly generally designated 2 comprising an optical fibre 4, a shroud 6, a composite material 8 and a coating 10. The composite material 8 comprises a settable matrix and a large number of longitudinally extending filaments. In one embodiment the composite 8 comprises PVDF and para-aramid fibres, such as those sold under the Kevlar trade mark, wherein the PVDF comprises approximately 60% of the volume of the composite material 8. In this example the coating 10 comprises 100% PVDF.

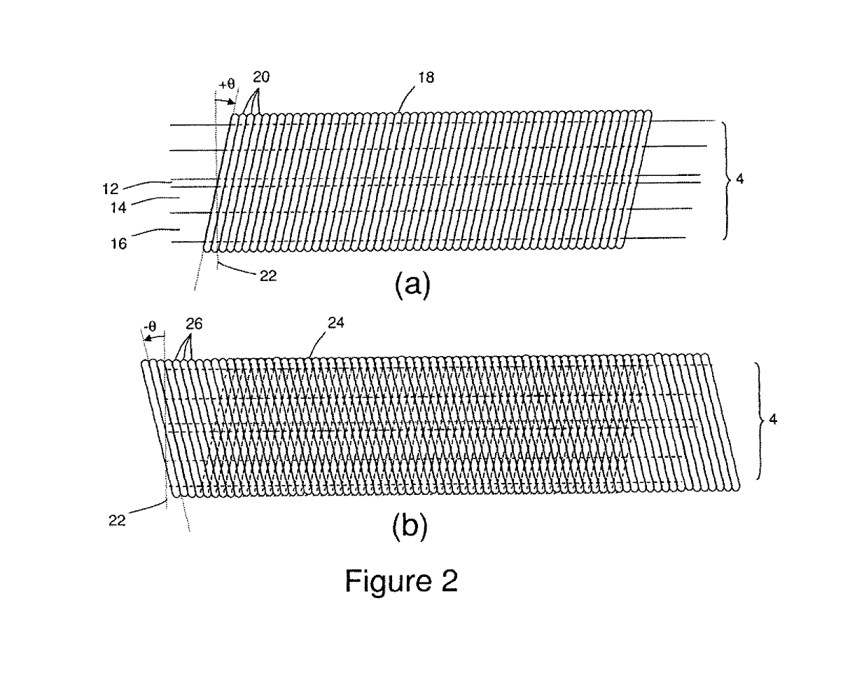

As illustrated in FIGS. 2(a) and 2(b) the optical fibre 4 comprises a core 12, a clad 14 and an acrylate coating 16.

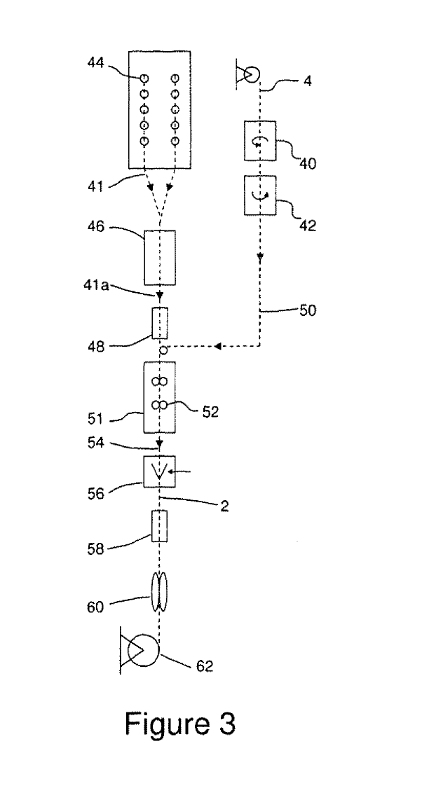

As shown in FIGS. 2(a) and 3, the method of manufacturing the optical fibre assembly 2 begins with a step of wrapping a plurality of Kevlar filaments 18 around the optical fibre 4 in a clockwise direction to form part of the shroud 6. This is achieved using a first wiring or cable-forming machine 40. Each loop 20 formed by wrapping the plurality of Kevlar filaments 18 around the optical fibre 4, forms an angle +0 relative to a radial direction 22. Subsequently, as shown in FIG. 2(b), a further plurality of Kevlar filaments 24 are wrapped around an outer surface of the plurality of Kevlar filaments 18 in an anti-clockwise direction using a second wiring machine 42. As shown in FIG. 2(b), each loop 26 of the further plurality of Kevlar filaments 24 are wrapped at an angle −θ relative to the radial direction 22 so that the further plurality of Kevlar filaments 24 cross the plurality of Kevlar filaments 18 to form the shroud 6.

The composite material 8 and the coating 10 are formed around the wrapped optical fibre sub-assembly of FIG. 2(b) in a pultrusion process, as will now be described with reference to FIG. 3. It should be noted that this process shares many features with the process described in detail in applicant's co-pending UK patent application GB0918888.9, the disclosure of which is incorporated herein in its entirety. The Kevlar filaments 41 of the composite 8 are initially provided on a large number of filament creels 44, and are then passed through a chamber 46 where the filaments 41 are impregnated with resin, in liquid or dry powder form. The impregnated filaments 41a are then heated or otherwise treated at a resin-fixation station 48, before the shrouded optical fibre 50 is fed into the centre of the loose bundle of resin-impregnated filaments 41a. The impregnated filaments 41a and the shrouded fibre 50 are then pulled through a pultrusion station 51 comprising a series of heated roll-forming dies 52. The resulting compact cylindrical bundle 54 is then passed through an extruder 56 where the coating 10 is applied. A quality control station 58 then measures or determines various dimensions or properties of the resulting assembly 2, for example checking to ensure there is no unacceptable necking or ovality. The assembly 2 then passes around a puller winch 60, before being coiled onto a haul-off winch 62.

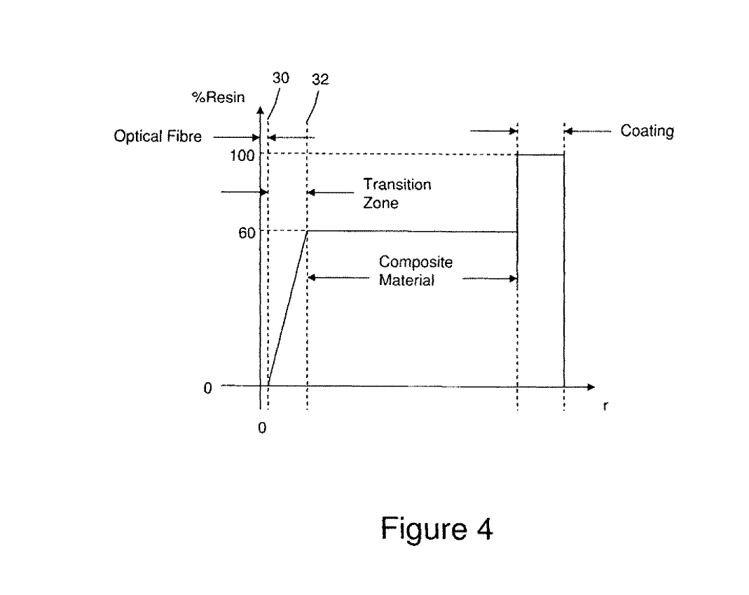

As shown in FIG. 4, the shroud permeability, relating to, among other things, the form of the shroud and the process parameters utilised during the assembly-forming process (including temperature, material selection, resin viscosity, pressure) are controlled so as to produce a settable material profile in the shroud 6 that changes from 0% by volume at the outer surface 30 of the optical fibre 4 to approximately 60% by volume at the interface 32 between the shroud 6 and the composite material 8. A transition zone is thereby formed in the shroud 6 in which the volume of settable material increases gradually from the outer surface 30 of the optical fibre 4 to the composite material layer 8.

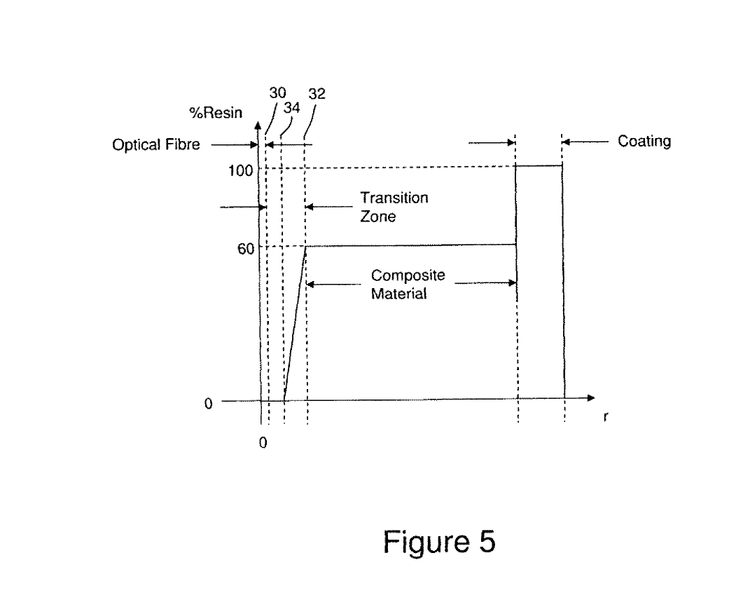

Further modifications of the embodiment described with reference to FIGS. 1 to 4 are also possible. For example, as shown in FIG. 5, the settable material may not penetrate all the way through the shroud 6, but the volume of settable material in the shroud 6 may vary from 0% by volume at a position 34 part way through the shroud 6 to a maximum at the interface 32 between the shroud 6 and the composite material 8. The volume proportion of settable material throughout the optical fibre assembly may also differ from the proportions illustrated in FIGS. 1 to 5.

In one alternative embodiment, the elongate body formed around the shroud may comprise only a settable material. Thus, no reinforcing fibres or filaments are present in the settable material, or such fibres or filaments may only be present in outer layers of the body.

Such an assembly may be manufactured by passing the transfer member and shroud through an extruder having a pressure die arrangement, the resin pressure within the die regulating the resin penetration depth in the shroud.

In a further alternative embodiment, a shroud may be pre-impregnated with settable material, before application of a composite material layer, or a solely settable material layer, to a transfer member and a shroud. For example, the transfer member may be wrapped in a first layer of shroud-forming material comprising no settable material. Subsequent layers of shroud-forming material may then be appled, each layer comprising an increasing volume or proportion of settable material, with the outermost layer comprising a volume or proportion of settable material the same or similar to the proportion of settable material present in the composite material layer.

The settable material present in the shroud may be melted or otherwise set during wrapping around the transfer member, following wrapping of the transfer member and prior to application of the composite material layer.

The settable layer present in the shroud may be melted or otherwise set during wrapping around the transfer member, following wrapping of the transfer member and prior to application of the composite material layer, or during application or formation of the composite material layer.

The settable material present in the shroud may be the same material as present in the composite material, or may be a different material but having similar properties, or properties selected to provides a gradual transition in force transfer across the shroud.

In each of the above-described embodiments, the proportion of settable material or resin present in the area of the assembly adjacent the transfer member transitions gradually, such that the material properties also transition gradually, avoiding the sharp interface in material properties that is present in conventional constructions, and which leads to an increased likelihood of failure.

What is claimed is:

1. A method of manufacturing a transfer member assembly comprising:
locating a shroud around a transfer member;
forming an elongate body comprising a settable material around the shroud; and
controlling penetration of the settable material into the shroud so that the settable material extends at least part way into the shroud.

2. The method of claim 1, wherein the penetration of settable material into the shroud is controlled such that the volume of settable material present decreases with increasing proximity to the transfer member.

3. The method of claim 1, comprising controlling at least one of the temperature, viscosity and pressure of the settable material.

4. The method of claim 1 comprising controlling the formation of the shroud and/or the settable material to control penetration of the settable material into the shroud.

5. The method of claim 1 comprising controlling the formation of the shroud and/or the settable material to prevent penetration of the settable material beyond an inner surface of the shroud.

6. The method of claim 1 comprising selecting the shroud and/or the settable material to control penetration of the settable material into the shroud.

7. The method of claim 1 comprising selecting the shroud material to have a predetermined porosity or permeability to the settable material.

8. The method of claim 1 comprising forming the shroud with a predetermined porosity to the settable material.

9. The method of claim 1 comprising forming the shroud with a predetermined thickness.

10. The method of claim 1 comprising controlling the formation of the shroud and/or the settable material to form a predetermined distribution of the settable material in the shroud.

11. The method of claim 1 comprising wrapping at least one shroud element around the transfer member.

12. The method of claim 11 comprising controlling at least one of the shape, size, and the wrapping arrangement of the at least one shroud element.

13. The method of claim 11 comprising controlling the number of shroud elements wrapped around the transfer member.

14. The method of claim 11 comprising helically wrapping the at least one shroud element around the transfer member.

15. The method of claim 11 comprising wrapping at least one further shroud element around the at least one shroud element.

16. The method of claim 15 comprising wrapping the at least one further shroud element around the at least one shroud element in a direction opposite to a direction in which the at least one shroud element is wrapped around the transfer member.

17. The method of claim 15 comprising wrapping the at least one further shroud element around the at least one shroud element at an angle relative to the at least one shroud element such that the at least one further shroud element crosses the at least one shroud element.

18. The method of claim 1, wherein the elongate body comprises solely or primarily a settable material.

19. The method of claim 1, wherein the elongate body comprises a composite material.

20. The method of claim 1, wherein the composite material comprises a matrix comprising a settable material and fibres or filaments distributed within the matrix.

21. The method of claim 1 comprising forming the shroud and/or the settable material using a pultrusion process.

22. A transfer member assembly comprising:
a transfer member;
a shroud around the transfer member; and
an elongate body comprising a settable material formed around the shroud, wherein the settable material penetrates at least part way into the shroud.

23. The transfer member assembly of claim 22, wherein the volume of settable material present in the shroud decreases with increasing proximity to the transfer member.

24. The transfer member assembly of claim 22, wherein the transfer member comprises at least one of a signal, power or fluid transfer member.

25. The transfer member assembly of claim 22, wherein the transfer member comprises at least one of an optical fibre, an electrical conductor, a gas or hydraulic line.

26. The transfer member assembly of claim 22 comprising a hollow tube with a loose-buffered optical fibre therein, or a support member surrounded by an optical fibre.

27. The transfer member assembly of claim 26, wherein the hollow tube or the support member comprises a gel-based material.

28. The transfer member assembly of claim 22, wherein the shroud comprises a layer or sheet of material.

29. The transfer member assembly of claim 22, wherein the shroud is porous or permeable to the settable material.

30. The transfer member assembly of claim 22, wherein the shroud comprises at least one elongate shroud element.

31. The transfer member assembly of claim 30, wherein the at least one elongate shroud element comprise a filament comprising at least one of a para-aramid, a meta-aramid, glass, PBO, carbon and a metal.

32. The transfer member assembly of claim 30, wherein the at least one shroud element is wrapped around the transfer member.

33. The transfer member assembly of claim 32, wherein the at least one shroud element is helically wrapped around the transfer member.

34. The transfer member assembly of claim 32, wherein the shroud comprises at least one further shroud element wrapped around the at least one shroud element.

35. The transfer member assembly of claim 34, wherein the at least one further shroud element is wrapped in a direction opposite to a direction in which the at least one shroud element is wrapped around the transfer member.

36. The transfer member assembly of claim 34, wherein the at least one further shroud element is wrapped at an angle relative to the at least one shroud element such that the at least one further shroud element crosses the at least one shroud element.

37. The transfer member assembly of claim 22, wherein the settable material comprises at least one of a thermoplastic material, an elastomer, a thermosetting material, an adhesive, an epoxy and a resin.

38. The transfer member assembly of claim 22, wherein the elongate body comprises a composite material.

39. The transfer member assembly of claim 38, wherein the composite material comprises a matrix comprising a settable material and fibres or filaments distributed within the matrix.

40. The transfer member assembly of claim 22, the elongate body comprises a plurality of elongate shroud elements.

41. The transfer member assembly of claim 40, wherein the plurality of shroud elements comprises at least one of a para-aramid, a meta-aramid, glass, PBO, carbon and a metal.

42. The transfer member assembly of claim 22, comprising a plurality of transfer members.

43. A transfer member assembly comprising:
a transfer member; and
an elongate body surrounding the transfer member and comprising a settable material, the body including a transition layer adjacent the transfer member, the proportion of settable material present in the transition layer decreasing with increasing proximity to the transfer member.

44. A method of manufacturing a transfer member assembly comprising a transfer member, the method comprising:
forming an elongate body comprising a settable material around the transfer member, the body including a transition layer adjacent the transfer member configured such that the proportion of settable material present in the transition layer decreases with increasing proximity to the transfer member.

45. The method of claim 44, wherein the transition layer is pre-formed, pre-filled or otherwise impregnated with settable material prior to being located around the transfer member.

46. The method of claim 44, wherein settable material is impregnated or otherwise supplied as the transition layer is formed around the transfer member.

47. The method of claim 44, wherein the transition layer is formed separately of other parts of the elongate body.

48. The method of claim 44, wherein the transition layer is formed simultaneously with other parts of the elongate body.

49. A cable comprising the transfer member assembly of claim 22.

50. A reelable support comprising the transfer member assembly of claim 22.

51. A slickline or a wireline comprising the transfer member assembly of claim 22.
